(19) United States
(12) Patent Application Publication
(10) Pub. No.: US 2011/0113177 A1
(43) Pub. Date: May 12, 2011

(54) SERVER AND UPDATE METHOD THEREOF

(75) Inventors: Lin Yu, Shanghai City (CN); Chih-Wei Chen, Taipei City (TW)

(73) Assignee: INVENTEC CORPORATION, Taipei City (TW)

(21) Appl. No.: 12/649,731

(22) Filed: Dec. 30, 2009

(30) Foreign Application Priority Data
Nov. 9, 2009 (CN) 200910211874.0

(51) Int. Cl. G06F 13/00

(52) U.S. Cl. 710/301

(57) ABSTRACT

A server is provided, and the server includes an embedded management board (EMB), a management backplane and a plurality of independent motherboards. The management backplane is coupled to the EMB. The plurality of motherboards respectively coupled to the management backplane and issues a command for performing a data-update on the EMB. Each motherboard of the plurality of independent motherboards includes a network interface and a management controller. The network interface receives a control command issued from a far-end device. The baseboard management controller coupled to the network interface for receives the control command and sends the command to the plurality of independent motherboards, wherein the each motherboard of the plurality of independent motherboards includes an individual on/off function. When the EMB is working, the EMB switches to connect with the plurality of motherboards through the management backplane by an polling method.

### CROSS-REFERENCE TO RELATED APPLICATION

This application claims the priority benefit of China application serial no. 200910211874.0, filed on Nov. 9, 2009. The entirety of the above-mentioned patent application is hereby incorporated by reference herein and made a part of specification.

### BACKGROUND OF THE INVENTION

1. Technical Field

The present invention relates to a server. More particularly, the present invention relates to a server and a refresh method thereof.

2. Description of Related Art

Generally speaking, some servers include a plurality of motherboards, and these motherboards work independently. In other words, these motherboards are not connected to each other and signals are not being transmitted there-between. These motherboards at most share a common power. Using the power-on of each motherboard as an example, the power-on control is achieved through directly controlling the power provided by power supply by the power-on circuit of each board. In other words, when the motherboards need to work, a control signal is sent to notify the power supply for providing power.

However, in a server, as the number of motherboards continues to increase and a common power is used in providing power, the numbers of the motherboards and power supplies become incompatible, leading to a power overload. Hence, the server may not be able to work normally. Further, the increase of the amount of signals inside the server may also demand interactions between the motherboards. Accordingly, a unified management method of plurality of motherboards in the server is being actively pursued in the industry.

### SUMMARY OF THE INVENTION

The present invention provides a server and an update method thereof, in which data update of the embedded management boards (EMB) is achieved. Further, subsequent to a malfunction occurs in one of the EMB, the task of data update is achieved through another EMB.

The present invention provides a server that includes a first EMB, a management backplane and a plurality of independent motherboards. The management backplane couples to the first EMB. The plurality of independent motherboards respectively couple to the management backplane and sends out commands for data-updating the first EMB. The plurality of independent motherboards respectively includes a network interface and a baseboard management controller (BMC). The network interface receives a control command sent from a far-end device. The BMC coupled to the network interface receives the above-mentioned control command and sends out the above-mentioned command. The above-mentioned command is transmitted via the management backplane, and each of the plurality of independent motherboards has an individual on/off function. When the first EMB is operating, the first EMB sequentially switches to connect with the plurality of independent motherboards via the management backplane by a polling method.

In one exemplary embodiment, when the first EMB enters the stand-by mode, the polling action stops.

In one exemplary embodiment, the above server also includes a second EMB, coupled to the first EMB and the management backplane. One of the independent motherboards sends out the above-mentioned command for performing data-updating on the first EMB or the second EMB, wherein the first EMB or the second EMB constantly detecting the status of each other to determine which one of the EMB is in a working status and which one is in a stand-by status. When the second EMB is operating, it sequentially switches to connect with the plurality of independent motherboards through the management backplane by the polling method.

According to an exemplary embodiment of the invention, when the first EMB is in a normal working status, activate signals are generated, and the second EMB is not operating; and when the first EMB is not in a normal working status, activate signals are not generated and the second EMB starts to work. When the second EMB is in a working status, activate signals are generated, and the first EMB is not operating; and when the second EMB is not in a normal working status, activate signals are not generated, and the first EMB starts to work.

According to an exemplary embodiment of the invention, when the above second EMB receives the above-mentioned command, the polling action stops.

The present invention provides an update method of the above-mentioned server. A first EMB and a plurality of independent motherboards are provided, wherein each of the plurality of independent motherboards has an internet interface and a BMC. Thereafter, the above first EMB is in a working status, and first EMB sequentially switches to connect with the plurality of motherboards by a polling method. Then, the network interface receives a control command issued from a far-end device. Thereafter, the BMC receives the control command. After this, when the first EMB switches to one of the plurality of motherboards, the BMC of the current motherboard issues a first command depending on the above-mentioned control signal to the first EMB. Thereafter, the first EMB checks whether the first command includes an update instruction. If the first command includes an update instruction, the first EMB stops the polling and enters an update status. Then, the BMC of the current motherboard issues a second command to perform data-updating on the first EMB.

According to an exemplary embodiment, when the first EMB determines that the first command does not include an update instruction, the first EMB switches to the next motherboard to continue with the subsequent operation and the polling action on the plurality of independent motherboards.

According to an exemplary embodiment of the invention, the update method further includes the following steps. A second EMB is provided. The first EMB and the second EMB detect each other, wherein one of the EMB is in a working status and the other is in a stand-by status.

In an exemplary embodiment, the update method further includes the following steps. When the first EMB is malfunction, the second EMB starts to work and sequentially switches to connect with the plurality of motherboards by the polling method. Then, when the second EMB switches to one of the plurality of independent motherboards, the current motherboard issues a first command. Thereafter, the second EMB checks whether the first command includes an update instruction. If the first command includes an update command, the second EMB stops the polling and enters into a stand-by status. Thereafter, the current motherboard issues an update command for performing the update of the second EMB.

According to an exemplary embodiment of the invention, the update method further includes the following steps. When malfunction occurs in the first EMB, the second EMB starts to work and sequentially switches to connect with the plurality of independent motherboards by the polling method. When the second EMB switches to one of the plurality of independent motherboards, the current motherboard issues a third command to the second EMB to signify that data updating is going to be performed on the first EMB. Then, the second EMB stops the polling action and connects the first EMB with the above-mentioned current motherboard. Further, the current motherboard sends out an update command to perform data update of the first EMB. After the completion of data update, the current motherboard issues a fourth command to the second EMB, so that the second EMB switch to the next mother board and continue with the subsequent operation. Further, the polling action is continued to perform on the plurality of the independent motherboards.

In according to the invention, the motherboards issue a command to complete the data update of the first EMB or the second EMB. When malfunction occurs on the first EMB, the second EMB takes over the task of the first EMB. Further, with the polling process of the second EMB, data update is performed on the first EMB by one motherboard. The task of data update of the first EMB is achieved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a server according to an exemplary embodiment of the invention.

FIG. 2 is a flow chart of steps in exemplary processes that may be used in the updating method of the server in FIG. 1.

FIG. 3 is a flow chart of steps in exemplary processes that may be used in the renew method of the server in FIG. 1.

### DESCRIPTION OF THE PREFERRED EMBODIMENTS

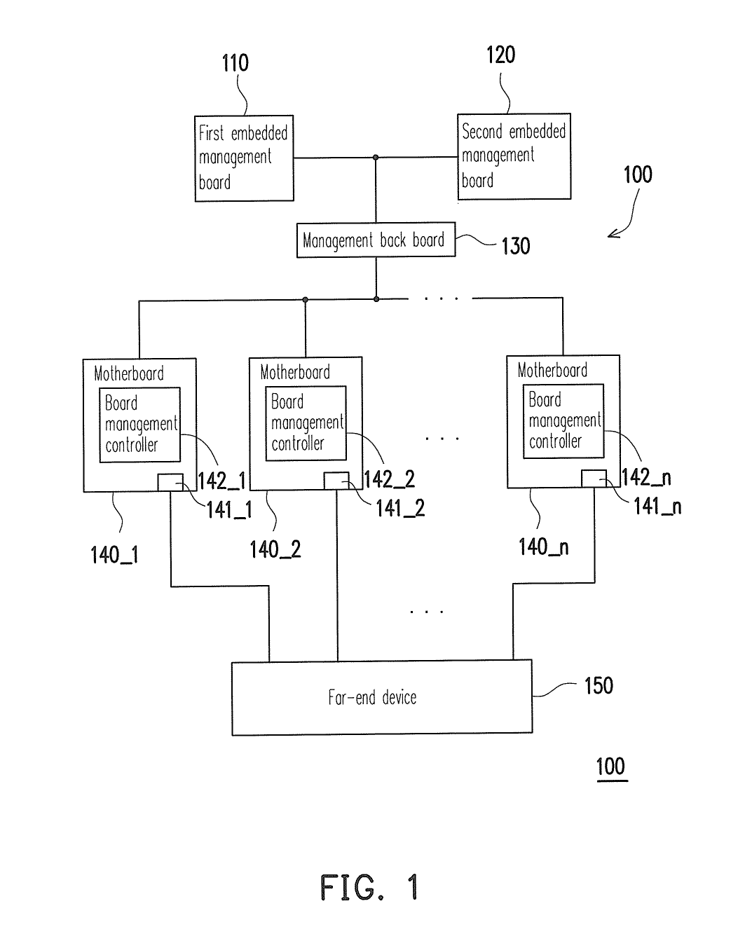

FIG. 1 is a schematic diagram of a server according to an embodiment of the invention. Referring to FIG. 1, a server 100 includes a first embedded management board (EMB) 110, a management backplane 130 and a plurality of independent motherboards 140_1 to 140_{—}n, wherein n is a whole number greater than 0.

The management backplane 130 is coupled to the first EMB 110. The motherboards 140_1 to 140_{—}n coupled to the management backplane 110 issue a command for updating the first EMB 110. In this embodiment, each motherboard 140_1 to 140_{—}n includes a network interface 141_1 to 141_{—}n and a baseboard management controller (BMC) 142_1 to 142_{—}n, respectively. The network interface 141_1 to 141_{—}n are used to receive a control command, sent by a far-end device 150, for controlling the motherboards 140_1 to 140_{—}n in performing the corresponding operations. The BMC 142_1 to 142_{—}n respectively couple to the network interfaces 141_1 to 141_{—}n to receive the control commands from the network interfaces and issue the above-mentioned commands. The above-mentioned commands are transmitted via the management backplane 130. The above-mentioned commands may include the Original Equipment Manufacturer (OEM) issue commands, the update commands and the OEM get commands. Further, each of the motherboards 140_1 to 140_{—}n includes an individual on/off function in order to work independently.

In this exemplary embodiment, the first EMB 110, in a normal working mode, sequentially switches the connection with the motherboards 140_1 to 140_{—}n through the management backplane 130 by a polling method. Further, when the first EMB 110 enters the update mode, the polling action stops. Moreover, in this embodiment, the data transmission between the first EMB 110 and the motherboards 140_1 to 140_{—}n is conducted through the intelligent platform management bus (IPMB).

Continuing from the coupling relationships between and the functions of the various devices in the above-mentioned server 100, the operation of the server 100 is now being described. When the first EMB 110 is switched to the motherboard 140_1, the motherboard 140_1 sends out an OEM get command to the first EMB 110. Then, the first EMB 110 checks whether the OEM get command includes an update instruction.

If the OEM get command does not include an update instruction, the first EMB 110 switches to the next motherboard 140_2 to continue with the subsequent operation. When the first EMB 110 switches to the motherboard 140_2, the motherboard 140_2 sends out an OEM get command to the first EMB 110. Then, the first EMB 110 checks whether the OEM get command includes the update instruction, and if the OEM get command does not include an update instruction, the first EMB 110 switches to the next motherboard 140_3. The polling action of the first EMB to the remaining motherboards is similar to the disclosure above and will not be reiterated herein.

On the other hand, if OEM get command sent by the motherboard 140_1 includes an update instruction, the motherboard 140_1 sends out an OEM issue command to the first EMB 110 to erase the OEM command so that the first EMB 110 enters into an update mode. When the first EMB 110 enters the update mode, the first EMB 110 ceases the polling action (in other words, the first EMB 110 will not switch to motherboard 140_2), and waits for the current motherboard 140_1 to send out an update command in order to update data on-line. When the data is updated, the first EMB 110 resumes the polling and switches to the next motherboard to perform the subsequent operation. The data update of the first EMB 110 by the remaining motherboards 140_2 to 140_{—}n is as discussed above and will not be further reiterated.

Further, in an exemplary embodiment, the server 100 further includes a second EMB 120. The second EMB 120 is coupled to the first EMB 110 and the management backplane 130, and the motherboards 140_1 to 140_{—}n send out the above-mentioned commands to update the data of the EMB 110 or the second EMB 120. Moreover, when the second EMB 120 is working, the second EMB 120 sequentially switches to connect with the motherboards 140_1 to 140_{—}n via the management backplane 130 by polling method.

Moreover, the first EMB 110 and the second EMB 120 constantly detect the status of each other to determine whether to work. For example, when the first EMB 110 is in a normal working status, activate signals are generated and the second EMB 120 is in a stand-by status (the second EMB 120 is not working). When the first EMB 110 is not in a normal working status (for example, malfunction occurs), activate signals are not generated and the second EMB 120 takes over the operation of the first EMB 110 (which is the task of controlling the power). Alternatively, when the second EMB 120 is in a normal working status, activate signals are generated, and the first EMB 110 is in a stand-by status (the second EMB 120 is not working). When the second EMB 120 is not in a normal working status, activate signals are not generated and the first EMB 110 takes over the operation of the second EMB 120. Moreover, during the inter-detection process in which the first EMB 110 and the second EMB 120 detect each other, not only the first EMB 110 or the second EMB 120 in an working status sends out activate signals, the EMB 120 or 110 that is in the stand-by status 120 also sends out detection signals and replies when no response is received from the other EMB within a particular time, the other EMB is considered to be malfunction.

In the exemplary embodiment, whether the first EMB 110 is in a working status and the second EMB 120 is in a stand-by status, or the second EMB 120 is in a working status and the first EMB 110 is in a stand-by status, the working EMB may refer to the above disclosure of the first EMB.

Further, the first EMB 110 may become malfunction during working, for example, a sudden power shut down of the server 100. When the power is resumed, the first EMB 110 and the second EMB 120 constantly detect the status of each other. The first EMB 110 is in the update mode or in fault and is unable to work. The second EMB 120 will not receive the activate signals generated by the first EMB 110 (this implies malfunction occurs in the first EMB 110). Then, the second EMB 120 takes over the operation of the first EMB 110 and sequentially connects with the mother boards 140_1 to 140_{—}n through the management backplane 130 via the polling. Further, not only data update is performed on the second EMB 120, data update can be performed on the first EMB 110 with the help of the second EMB 120. Reference will now be made in detail to another exemplary embodiment of the invention. In the foregoing exemplary embodiment, it is assumed that the user desires to update the first EMB 110 through the motherboard 140_3.

When the second EMB 120 switches to the motherboard 140_3 through the polling method, the motherboard 140_3 issues an original equipment manufacturer (OEM) send command to notify the second EMB 120 to data-update the first EMB 110. Thereafter, the motherboard 140_3 issues an OEM receive command to the second EMB 120 to confirm whether the second EMB 120 has received the OEM send command.

If the second EMB 120 fails to receive the OEM send command, the motherboard 140_3 reissues the receive command to confirm.

On the other hand, if the second EMB 120 receives the OEM send command, it is noted that the second EMB 120 has already received the update command of the first EMB 110, and the second EMB 120 remains waiting and stops the polling action (which is the switching to the motherboard 140_4), then the motherboard 1403 sends out the update command of the first EMB 110 to the second EMB 120 in order to perform the data update on the first EMB 110 through the second EMB 120. After being updated, the first EMB 110 is in a stand-by status.

After the first EMB 110 finishes the data update, the motherboard 1403 issues an update completion message to the second EMB 120 to notify the second EMB 120 that the first EMB 110 has already been completed update. Thereafter, the second EMB 120 switches to the next motherboard 140_4 to continue with the subsequent operation and the polling of the motherboards 140_1 to 140_{—}n. Moreover, one may refer to above disclosure of the data update method performed by the first EMB 110 in a normal working mode for the data update method performed by the second EMB 120; hence, the detail description thereof will not be further reiterated herein.

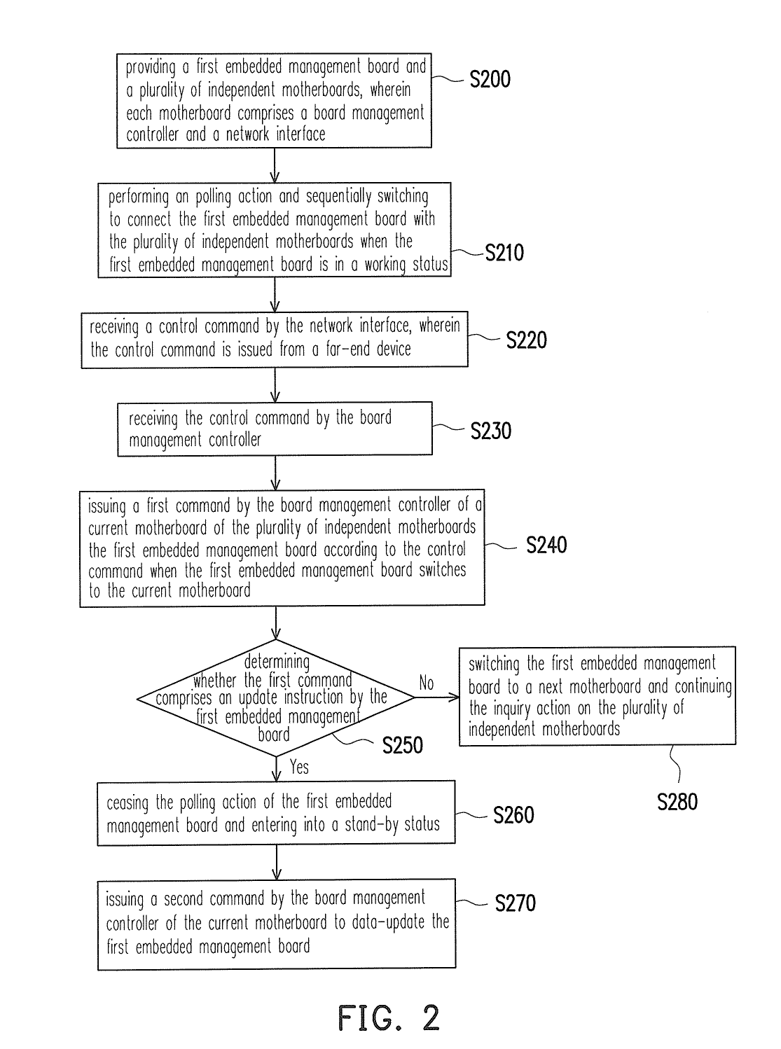

In accordance to the above exemplary embodiments, the update method of the server 100 with the EMB in a normal working status and the update method of the server with an EMB not in a normal working status are summarized. FIG. 2 is a flow chart of steps in exemplary processes that may be used in the updating method of the server in FIG. 1. The present embodiment may be implemented on a server that includes a first EMB (a server that does not include a second EMB) or a server that includes both the first EMB and the second EMB. Referring to FIG. 2, in step S200, a first EMB and a plurality of independent motherboards are provided, wherein each of the plurality of independent motherboards has a BMC and a network interface. Thereafter, in step S210, the first EMB, in a working status and using the polling method, sequentially switches the connection with the plurality independent motherboards. In step S220, the network interface receives the control command issued from a far-end device. In step S230, the BMC receives the above-mentioned control command. Thereafter, in step S240, when the first EMB switches to one of the plurality of motherboards, the BMC of the current motherboard issues a first command (OEM get command) depending on receiving the above-mentioned control command to the first EMB. Then, in step S250, the first EMB checks whether the first command includes an update command. If the first command includes an update instruction, step S260 is performed, in which the first EMB stops the polling action and enters an update status. Thereafter, in step S270, when the BMC of the previous motherboard issues a second command (update command), the first EMB performs the data update.

Alternatively, according to the above step S250, if the first command does not include an update instruction, step 280 is performed, in which the first EMB switches to a next motherboard. The polling of the plurality of motherboards continues and the subsequent operation proceeds.

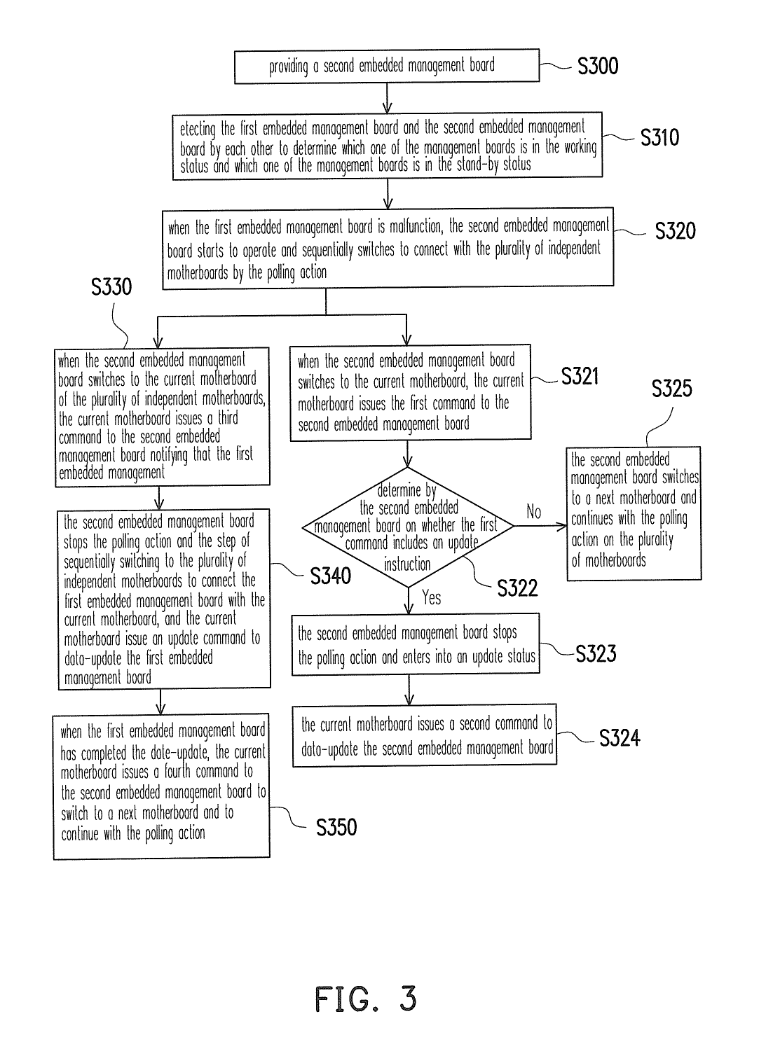

FIG. 3 is a flow chart of steps in exemplary processes that may be used in the update method of the server in FIG. 1. In this exemplary embodiment, a server including a first EMB and a second EMB is provided. Referring to FIG. 3, in step S300, the second EMB is provided. Then, in step S310, the first EMB and the second EMB detect the working status of each other, wherein one EMB is in a working status, while the other is in a stand-by status. Then, in step S320, when the first EMB is malfunction, the second EMB starts to work and sequentially switches the connection with the plurality of independent motherboards by the polling.

Thereafter, in step S330, the second EMB switches to one of the plurality of the motherboards, and when the current motherboard issues the third command (OEM send command) to the second EMB, it noted to perform data update on the first EMB.

In step S340, the second EMB stops the polling action and connects the first EMB with the current motherboard, and the current motherboard issues an update command to perform the data update of the first EMB. After the data update of the first EMB is completed, step S350 is performed, in which the current motherboard issues a fourth command (data update completion command) to the second EMB, so that the second EMB switches to the next motherboard and proceeds with the subsequent operation. Moreover, the polling action continues to perform on the plurality of independent motherboards. Additionally, one may refer to the steps of S220, S230, S24, S250, 260 in FIG. 2 for the steps S321, S322, S323, S324, 325 of data update performed on the second EMB.

According to the exemplary embodiments of the invention, the motherboard issues a command to complete the data update of the first EMB or the second EMB. When malfunction occurs of the first EMB, the second EMB takes over the operation of the first EMB. During the polling of the motherboards by the second EMB, data update of the first EMB is accomplished via a particular motherboard. Hence, the mission of data update of the first EMB is achieved.

Although the disclosure herein refers to certain illustrated embodiments, it is to be understood that these embodiments are presented by way of example and not by way of limitation. The intent of the detailed description is to cover all modifications, alternatives, and equivalents as may fall within the spirit and scope of the invention as defined by the appended claims. Moreover, any embodiment of the invention or claims to achieve all the features, advantages or characteristics disclosed in the invention. Additionally, the abstract and the title of the invention are intended to facilitate patent search and not intended to be restrictive of the spirit and scope of the invention.

What is claimed is:

1. A server, comprising:
a first embedded management board;
a management backplane, coupled to the first embedded management board; and
a plurality of independent motherboards respectively coupled to the management backplane, wherein each motherboard of the plurality of independent motherboards sends out a command for performing a data update on the first embedded management board, and each motherboard of the plurality of independent motherboards comprises:
a network interface, for receiving a control command issued from a far-end device; and
a baseboard management controller, coupled to the network interface for receiving the control command and sending out the command to the plurality of independent motherboards through the management backplane, wherein the each motherboard of the plurality of independent motherboards comprises an individual on/off function;
wherein when the first embedded management board is working, an polling action is performed in which the first embedded management board switches to connect with each of the plurality of independent motherboards through the management backplane by a polling method.

2. The server of claim 1, wherein when the first embedded management board enters an update mode, the polling action stops.

3. The server of claim 1 further comprising:
a second embedded management board, coupled to the first embedded management board and the management backplane, and one motherboard of the plurality of independent motherboards issues the command for performing the data update on the first embedded management board or the second embedded management board,
wherein the first embedded management board and the second embedded management board constantly detect each other to determine which one of the first embedded management board and the second embedded management board is in a working status and the other one of the first embedded management board and the second embedded management board is in a stand-by status,
when the second embedded management board is in a working status, the second embedded management board switches to connect with each of the plurality of independent motherboards through the management backplane by an polling method.

4. The server of claim 3, wherein when the first embedded management board is in the working status, activate signals are generated and the second embedded management board is stand-by status, and when the first embedded management board is in the stand-by status, the activate signals are not generated and the second embedded management board starts to work as in working status, and when the second embedded management board is in the working status, activate signals are generated and the first embedded management board is stand-by status, and when the second embedded management board is in the stand-by status, the activate signals are not generated and the first embedded management board starts to work as in working status.

5. The server of claim 3, wherein when the second embedded management board receives the command, the polling action stops.

6. An update method of a server, the method comprising:
providing a first embedded management board and a plurality of independent motherboards, wherein each motherboard of the plurality of independent motherboards comprises a baseboard management controller and a network interface;
performing an polling action and sequentially switching to connect the first embedded management board with the plurality of independent motherboards when the first embedded management board is in a working status;
receiving a control command by the network interface, wherein the control command is issued from a far-end device;
receiving the control command by the baseboard management controller from the network interface;
issuing a first command by the baseboard management controller of a current motherboard of the plurality of independent motherboards to the first embedded management board according to the received control command when the first embedded management board switches to the current motherboard of the plurality of independent motherboards; and
determining whether the first command comprises an update instruction by the first embedded management board, wherein
if the first command includes the update instruction, the polling action of the first embedded management board stops and the first embedded management board enters into an update stand-by status, and a second command is issued by the baseboard management controller of the current motherboard to data-update the first embedded management board.

7. The update method of claim 6, determining whether the first command comprises an update instruction by the first embedded management board, further comprising:
if the first command does not include the update instruction, the first embedded management board switches to a next motherboard and continues the polling action on the plurality of independent motherboards.

8. The update method of claim 6 further comprising:
providing a second embedded management board; and
detecting the first embedded management board and the second embedded management board by each other to determine which one of the first embedded management board and the second embedded management board is in the working status and the other one of the first embedded management board and the second embedded management board is in the stand-by status.

9. The update method of claim 8, wherein
when the first embedded management board is malfunction, the second embedded management board starts to work and sequentially switches to connect with the plurality of independent motherboards by performing the polling action; and
when the second embedded management board switches to the current motherboard, the current motherboard issues the first command to the second embedded management board, wherein
if the first command does not comprise the update command, the second embedded management board switches to the next motherboard and continues the polling action on the plurality of motherboards; and
if the first command comprises the update command, the second embedded management board stops the polling action and enters into the update stand-by status, and the current motherboard issues the update command to data-update the second embedded management board.

10. The update method of claim 8, wherein
when the first embedded management board is malfunction, the second embedded management board starts to work and sequentially switches to connect with the plurality of independent motherboards by performing the polling action;
when the second embedded management board switches to the current motherboard of the plurality of independent motherboards, the current motherboard issues a third command to the second embedded management board signifying the first embedded management board is to be data-updated;
the second embedded management board stops the polling action and the step of sequentially switching to the plurality of independent motherboards to connect the first embedded management board with the current motherboard, and the current motherboard issues an update command to data-update the first embedded management board; and
after the first embedded management board has been date-updated the current motherboard issues a fourth command to the second embedded management board to switch to a next motherboard, the second embedded management board goes on to sequentially switch to connect with the plurality of independent motherboards by performing the polling action.
